(19) United States
(12) Patent Application Publication
(10) Pub. No.: US 2020/0263923 A1
(43) Pub. Date: Aug. 20, 2020

(54) GRAIN AERATION BIN

(71) Applicant: Brent J. Bloemendaal, Zionsville, IL (US)

(72) Inventor: Brent J. Bloemendaal, Zionsville, IL (US)

(21) Appl. No.: 16/791,599

(22) Filed: Feb. 14, 2020

Related U.S. Application Data
(60) Provisional application No. 62/806,089, filed on Feb. 15, 2019.

(51) Int. Cl. F26B 3/06; F26B 21/08; F26B 9/06; F26B 9/08; F26B 21/10; F26B 25/22

(52) U.S. Cl. CPC F26B 3/06; F26B 21/08; F26B 9/063; F26B 2200/06; F26B 21/10; F26B 25/22; F26B 9/082

(57) ABSTRACT

A process for drying grain wherein a fan cooperates with a heater to flow air through grain that is wetter than a target, wherein the fan is operated at full speed and the heater is varied in output to operably compensate for changes in the air and in particular to raise the amount of water vapor the circulating air removes from the grain.

### CROSS-REFERENCE TO RELATED APPLICATIONS

This application claims the benefit of U.S. provisional patent application Ser. No. 62/806,089, filed Feb. 15, 2019, the contents of which are incorporated herein by reference.

### BACKGROUND OF THE INVENTION

The process of drying grain to a target content of moisture and thereafter the grain is stored wherein grains, such as wheat, corn, rice, soy beans or the like are allowed to set, is not a simple process. During the drying portion of the process, ambient air must be used when it is capable of removing moisture from the grain or it has to be conditioned to do so. Over much of the year, the surrounding air is too cold or too wet to remove moisture from the grain. During the storage portion of the process it is important to circulate air through the grain to prevent the development of mold and clumps and to try to maintain the correct amount of moisture in the grain. Virtually all grain is initially harvested with too high an internal moisture content for market. Therefore, it is usually desirable to remove moisture to a desired or target level. In particular, farmers may receive a financial penalty if they deliver grain to market that has a moisture content above a certain prescribed level and they lose income if the moisture content is below that level, because the grain weighs less. Consequently, farmers try to achieve and then maintain the target moisture content.

Because it is important to aerate the grain even when not drying, air driven by a large blower fan is normally blown into the bottom of the grain in the bin and up through the grain. This can result in over drying. The ability of the ambient air to take up additional moisture is volatile and depends on multiple factors, such as the current moisture content of the grain, the ambient temperature of the air, the ambient humidity of the air, and even such factors as the porosity of the shell surrounding the grain.

Conventional bin operation has normally placed the grain in bins when harvesting is complete after which the operator does some aeration, but often waits for periods when the ambient temperature and humidity are best for removing moisture to a desired level before fully drying the grain and then maintaining that level. Unfortunately, these desired levels of ambient temperature and humidity are short in the Fall and Spring and may exist only a few hours a day, so it can take a long time for the grain to dry to a desired level. Even after reaching the desired level, if the air is too wet, then aeration can actually drive additional unwanted moisture into the grain, if the air is too hot then it may remove too much moisture and the like.

Many of the bin control processes currently in use, either over or under dry the grain and/or are expensive to operate and/or take a significant time to dry.

A process for drying and maintaining moisture content of grain at a target value wherein the grain drying system utilizes a variable speed fan or a constant speed fan and a variable output heater. The heater being able to operate at a low heat output in the range of 10,000 BTU or below and cooperating with flow of air from the fan to raise the temperature of the air in the range of just above 0° to 2° F. The heater is preferably modular in operation and in some embodiments can operate through an output range to raise the air temperature from just above 0° F. to 20° F. or, preferably, from 0° to 7° F. Normally, 10,000 BTU heating of air form the fan produces about 1° F. raise in temperature whereas 25,000 BTUs will raise the air temperature about 2.5° F. and that would be the normal highest heat impact. However, it is seen that the heater be capable of up to 200,000 BTU output which would produce a 20° F. raise in the temperature of the drying air. When the ambient conditions are such that moisture from the grain can be transferred into the air and the moisture in the grain is above the target moisture, the fan is operated at full constant speed and the heater output is varied as needed to draw the moisture out of the grain to be discharged into the air and from the bin with the circulating air. When the air conditions produce a drying effect and the grain is already at target, the heater is stopped, and the fan is run at an ever decreasing rate relative to the drying effect of the air so that air can be circulated as long as possible to prevent mold and other effects of air stagnation.

### BRIEF DESCRIPTION OF THE DRAWINGS

FIG. 1 is a side elevational view of a grain dryer system with portions broken away to illustrate detail and with certain portions shown schematically.

FIG. 2 is a chart showing a drying process.

### DETAILED DESCRIPTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

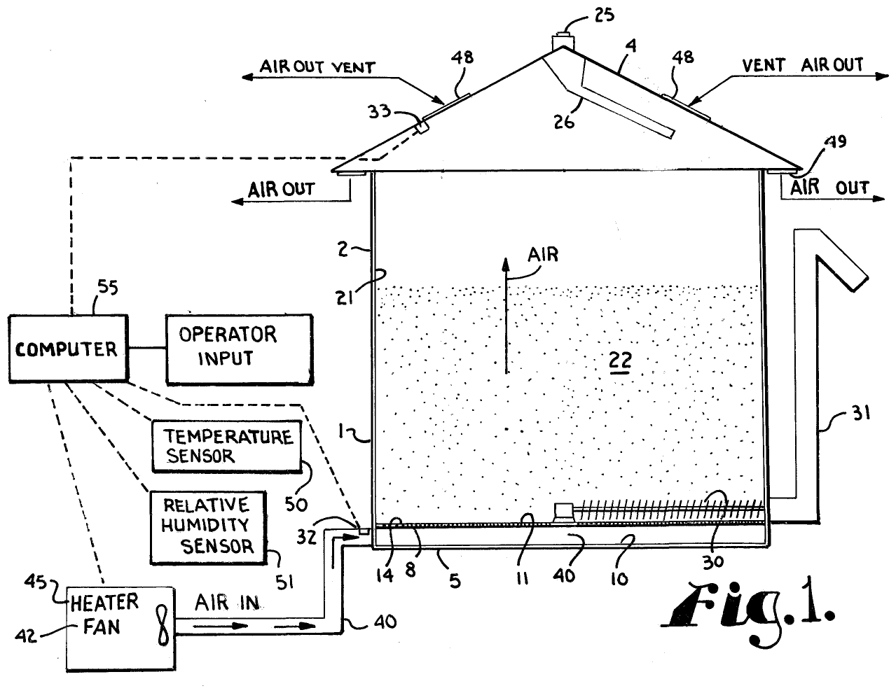

FIG. 1 shows a grain storage bin generally identified by the reference numeral 1. The bin 1 has a generally cylindrical or circular shaped and upright corrugated body 3 and a conical shaped roof 4. Typically, the bin 1 sets on a base 6 of concrete or the like and includes a raised floor 8. The base 6 has a substantially flat surface 10 and the floor 8 also has a generally flat upper surface 11. The floor 8 is spaced about one foot above the base 6 to give free air flow therebetween. The floor is also perforated with apertures 14 across the entire floor surface 11, so as to allow air to circulate and flow from beneath the floor 8 into the interior 21 of the bin 1. During normal operation, grain 22 fills or partially fills the bin interior 21 and is supported by the floor surface 11.

Grain 22 is normally initially placed in the bin 1 through an opening 25 in the roof 4. A spreader 26 is utilized to uniformly distribute grain 22 in the bin 1 to a preferred height (as shown); however, less can be inserted if insufficient supplies exist to fill the bin 1. An auger/sweep mechanism 30 is provided to remove the grain 22 from the bin 1 when shipping and convey the grain 22 into a discharge tube 31.

A first bin sensor 32 is located to measure the temperature and relative humidity of the air entering the bin 1 form the plenum 40 after heating, if any, by the heater 45.

A second bin sensor 33 is located on or near the roof 4 on the interior of the bin 1. The sensor 33 is able to measure the temperature and relative humidity of the air in the bin 1 after passing through the grain 22.

An air plenum 40 is a tube like structure and operably opens at one end thereof into the space 41 between the base surface 10 and the floor 4. The plenum 40 is also operably joined to the flow output of a fan 42 at the opposite end thereof. A heater element 45 is also positioned to receive and relatively heat air flowing from or to the fan 42.

Located on the roof 4 are a series of vents 48 that allow air to escape from the bin 1. Also, located along the juncture of the roof 4 and bin body 2 are a series of eaves 49 that also provide for escape of air. The vents 48 and eaves 49 are important in ensuring that the fan 42 (or fans) do not overpressure or otherwise overwhelm the bin 1 and do damage to it.

During drying and storage, the fan 42 discharges air therefrom into the space 41 either with or without heat form the heater element 45. The air in the space 41 passes through the apertures 14 and up through the grain 22 in a generally uniform pattern and thereafter through the vents 48 and/or eaves 49 in the roof 4.

Disclosed herein is a method or process of drying grain in the bin 1 subsequent to harvest of the grain and thereafter maintaining the grain. Farmers choose a target through operator input 56 for the percentage of moisture in the grain when it is taken from the storage bin 1 to a buyer. Often, the target is about 15% moisture content for corn, while other grains may be lower or higher ideal storage moisture content. Importantly, it is desirable not to be above or below the target. If the grain is higher than the target in percentage of moisture when taken to market, then the grower receives a lower price or a penalty is imposed by the buyer. Furthermore, if the grain is stored in the bin 1 at too high a moisture content, then the grain has a tendency to become moldy and crusty which is undesirable. Normally, over dried grain is not penalized by the buyer. The grain in storage is a living system, especially with microorganisms, mold and insects living therein. The principal problem is the mold, which eats and degrades the grain, but requires moisture and stagnant air to grow. Letting moisture collect on the surface of the grain or fully stopping air flow through the grain promotes mold growth.

In grain drying and maintenance the term equilibrium moisture content (EQM or EMC) refers to the situation wherein the vapor pressure of the water vapor within the grain is equal to the vapor pressure in the air surrounding the grain. If the water vapor pressure in the grain is higher than the surrounding air, then the grain dries. If the vapor pressure of the air in the grain is lower than the surrounding air, then the grain becomes wetter or has a higher moisture content. Consequently, the EMC is important to watch over the entire time the grain 22 is in the bin 1, because the EMC changes continuously over time as ambient air heats and/or changes in relative humidity, and especially cycles over the day and even over the seasons.

In the grain drying process, grain 22 is placed in the bin with sensors 32 and 33 that are positioned to be located below and above the grain 22 in the bin 1. Sensors 32 and 33 work in conjunction to compare the air temperature and relative humidity at sensor 33 to sensor 32 to see if the drying process is complete. In particular, if the target equilibrium and the temperature of both are the same, then no drying is occurring and the process is complete, so the fan 42 can be turned off to prevent waste of energy. The sensors 33 are conventional and measure the moisture content, temperature and other parameters of the air surrounding each sensor 32 and 33 unit. The temperature and relative humidity of the outside or ambient air is determined continuously by temperature sensor 50 and relative humidity sensor 51.

Normally, the incoming grain 22 will be above the target range which is often 15% moisture content. The readings from the sensors 22, 50, and 51 are processed by a computer 55 based upon a predetermined algorithm that is normally developed by operation over time. The computer 55 is operably linked with and operates the fan 42 and sometimes the heater element 45 in the manner described below. The operator must decide the specific operating parameters of their bin system as conditions vary. Consequently, the width or operational parameters of zones noted herein vary with location and ambient conditions. For example, some areas are very dry whereas others are very rainy and wet.

For initial drying of the just harvested to the target moisture, the ambient air does not often cooperate to make the process function quickly and easily. A special window is typically open in the Fall (part of October and November) and in the Spring (part of April and May) during a portion of each day where the conditions are just right where the EMC is such that air circulation will remove moisture during about 30% of a 24 hour period (or about 6 hours a day). A typical air supply fan, which has an output of about one to one-half cubic feet of air per minute per bushel of grain 22 stored in the bin 1, requires about 4 to 6 weeks of operation to bring grain 22 with an original 17% moisture content to achieve target level of 15% moisture content when operating under prior art processes. The fan 42 used herein is variable in speed and may operate in a wide range, for example one-seventh to one-half cubic feet of air per minute per bushel of grain 22. It is possible to use fan speeds above one-half cubic feet per bushel per minute and put a large flow through the grain when conditions are just right for drying; however, this wastes a large amount of energy. In the present process, using only a low flow rate fan and such a fan in combination with a heater, the air temperature (and hence capacity to remove moisture) is raised so as to raise the window within which drying occurs. In this manner, the EMC is maintained so as to get the same or more drying using less overall fan horsepower and, consequently, less energy.

In conventional driers, the fan is stopped when the EMC goes either above or below a predetermined window to prevent moisture acquisition by the grain or over drying. The problem with stopping the fan is that a drying front can occur in the grain where moisture accumulates due to condensation because liquid water has changed to vapor with consequent cooling which in turn causes moisture to accumulate on the grain. The accumulated moisture is not removed by air flow because the fan is not operating. The moisture condensate resulting from the stagnation of air due to no fan operation is an excellent breeding arena for mold which grows and degrades the grain while the mold forms a very undesirable crust. The alternative has been to keep the fan running at fully speed which wastes energy, if the fan runs a full speed when the EMC is too high or too low.

In the present process, the heater element 45 can be much smaller than conventional heater units. Preferably, the prior art heater elements put out about 250,000 BTUs and are on-off units. That is, they run continuously at full output or not at all. The heater element 45 used herein is preferably in the range of about 10,000 to 25,000 output BTU and besides being able to turn on and off has a variable range with the output range being between about 10,000 to 200,000 BTUs and preferably between about 10,000 to 25,000 BTUs.

The fan 42 and the heater element 45 cooperate under control of the controller program in the computer 55 to provide heat to the air circulated by the fan 42 and increase the time that the EMC is within the zone wherein the system is removing moisture from the grain 22 while the fan 42 circulates slightly heated air through the grain 22. The air may be heated as little as 1 to 2 degrees by the heating element. This has the effect of drying the grain 22 during approximately 80% of available hours in a day during the most effective periods and reduces the time to reach the target level by a factor of 3 compared to conventional dryer units.

Maintenance of the target moisture of grain 22 is accomplished by allowing the fan 42 to operate at a reduced or minimum speed to continuously circulate air through the grain 22. If ambient air will absorb too much moisture, the fan 42 is turned off. If it will absorb only some moisture, the fan 42 is run at a minimum speed. Between minimum speed and whereat the grain 22 is at target dryness, the fan speed varies to provide circulation, but not over dry the grain 22.

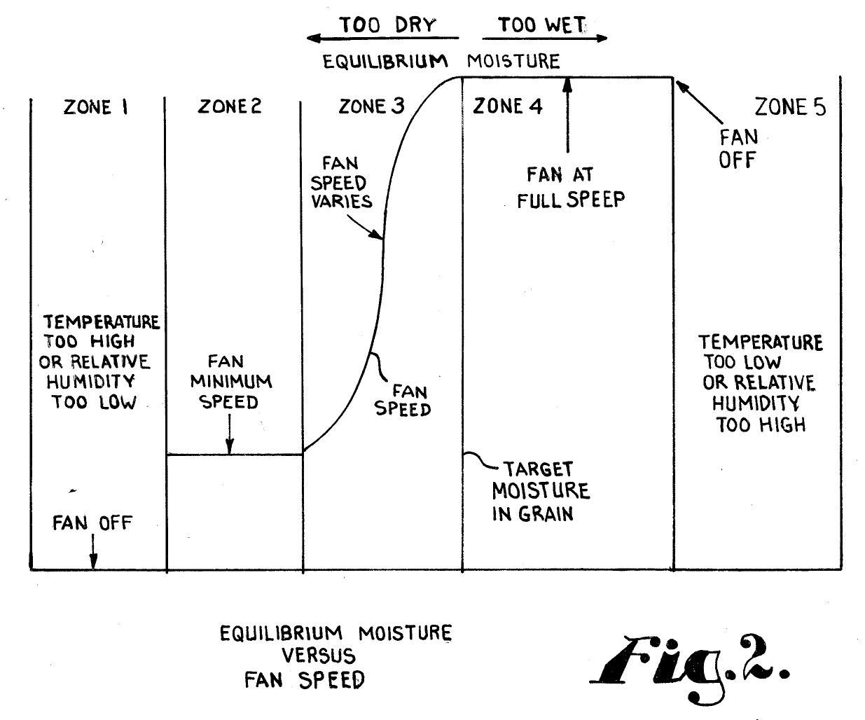

Shown in FIG. 2 is a graph which illustrates use of the process to dry and maintain grain at a target level of moisture. As noted above, when conditions are below the EMC (Zone 3), the fan 42 is slowed according to the moisture level until a selected level is reached (Zone 2) at which the fan 42 is maintained at a minimum speed until another or second level (Zone 1) is reached at which the fan is stopped to avoid serious over drying. When the conditions are above the EMC (Zone 4) where the grain is above the target moisture, not only the fan 42 operates at full speed, but the heater element 45 is turned on also (the only zone which is heated). At a third selected point (thereafter Zone 5), the ambient temperature is so low and/or the relative humidity is so high that it no longer makes sense to use energy to operate the fan 42 and heater element 45 because very little moisture can be removed, so the fan 42 and heater element 45 are both stopped until conditions favor restarting them. As noted, the operator selects the width or moisture difference of the zones based upon conditions present in the region where the dryer system bin 1 is located.

It is foreseen that in some embodiments, the drying system may not have a heater. In such, the fan operates at full speed when the moisture content is above target and the incoming air is capable of drying the grain 22. When below the target, the fan speed is ramped down as noted before to prevent or reduce over drying.

It is foreseen that in some embodiments, a further drying zone 4A occurs between the above noted embodiment's zones 4 and 5 wherefor a preselected period the speed of the fan 42 is slowly reduced from zone 4 along a curve preselected by the operator until the ambient conditions are such that very little or no moisture can be removed from the grain at which time the fan 42 is stopped as zone 5 is entered.

Having thus described the invention what is claimed as new and desired to be secured by Letters Patent is as follows:

1. A process for drying grain when the moisture content of the grain is above a preselected target moisture content, the process comprising the steps of:
a) providing a fan that operably propels air upward through the grain at a constant flow rate;
b) providing a heater element that is variable in heat output; the heating element having a lower heating range of between 10,000 and 25,000 BTUs;
c) providing a controller and sensor system that operably senses temperature and relative humidity of ambient air and the moisture content of the grain; and
d) the control and sensor system comparing the moisture content in the grain to the target and, if the air is operably able to absorb moisture and the grain is above the target moisture content, thereafter operating the fan and the heating element so that the fan operates at a full output thereof and the heater element is varied to heat the air in accordance with how high the level of moisture is within the grain and in view of ambient air conditions.

2. The process according to claim 1 wherein:
a) the heater element is operated to raise the temperature of the air imputed into the grain in the range of 0° to 2° F.

3. The process according to claim 1 wherein:
a) the heater element is operated to raise the temperature of the air approximately one degree F.

4. The process according to claim 1 including operation of the process wherein the grain is at or below the target and the ambient air temperature is too high or relative humidity too low comprising the additional steps of:
a) operating the fan at less than full speed along an operator preselected operating curve that provides circulation of air through the grain, but decreases as the ambient air conditions change relative to equilibrium moisture content between the air and grain such that the grain does not over dry except to a preselected level and, thereafter the fan is operated at a constant minimum level of air output until a shutoff level is reached where the operator selects to not have any more moisture removed from the grain whereat the fan is stopped completely.

5. A process of operating a grain bin system to dry grain in the bin to target moisture content and thereafter maintain the target moisture content until the grain is removed from the bin, the process comprising the steps of:
a) providing a grain bin suitable for receiving grain and having a floor region that allows for flow of air up into and through the grain therein;
b) providing a variable speed fan that has a plenum flowing air from the fan into the floor region and upward through the grain;
c) providing a heater element in flow communication with air driven by the fan;
d) providing a first sensor to determine ambient air temperature; a second sensor to determine ambient relative humidity;
e) a computer-controller operably linked to the first sensor, the second sensor, the fan and the heater element; the computer-controller operably processing inputs from the first sensor and the second sensor to determine if the grain is above target moisture content, at target moisture content or below target moisture content and then determining the following based upon first, second, third, fourth and fifth preselected moisture content zones:
1) in the first zone ambient air conditions are significantly below the target level and when in the first zone the fan is turned off; the first zone is located whereat an associated EMC is such that significant over drying of the grain would occur if the fan were to be operated;
2) in the second zone is whereat some over drying can occur, but operation of the fan is desirable to reduce mold growth and the fan is operated at minimal speed;
3) in the third zone the rate of the fan is increased along a preselected speed range until at maximum speed of the fan;
4) between the third and fourth zones the target moisture content is equal to the EMC above which the fan is operated at full capacity and the heater element is operated on a variable basis in the fourth zone on a preselected basis;
5) in the fifth zone, the fan and heater element are turned off as little moisture can be removed from the grain due to at least one of a low ambient temperature and high ambient humidity in the ambient air.

6. A process for drying grain comprising the steps of:
a) placing the grain in a bin,
b) connecting a variable speed fan to the bin and utilizing the fan to blow air through the grain;
c) setting a target moisture content for the grain;
d) choosing zones associated with ambient air condition and comparing the ambient air condition to the target moisture content;
e) when the ambient air is in a fifth zone where the relative humidity of the ambient air is too high and/or the temperature is too low, the fan is turned off;
f) when the ambient air is in a fourth zone wherein the air temperature relative humidity will dry the grain and the moisture content of the grain is above the target moisture content, the fan is operated at full speed;
g) when the grain is in a third zone wherein the grain is at or below target moisture content and the air has a relative humidity and temperature that would remove additional moisture from the grain, the fan is operated over a preselected curve between full speed and a selected minimum speed;
h) when the air conditions are in a second zone wherein the air conditions are such that a preselected relative humidity and temperature occur and are such as to remove moisture from the grain and the grain is at or below target moisture content, the fan is operated at the minimum speed thereof; and
i) when a preselected air temperature and relative humidity in a first zone occur wherein continued drying would significantly over dry the grain, the fan is completely stopped.

7. The process according to claim 6 wherein:
a) between the fifth zone and the fourth zone is a zone four A wherein the fan is operated to reduce output thereof between zones four and five along an operator preselected curve until when zone 5 is reached the fan is stopped completely.

8. A method of drying grain comprising:
a) initially placing the grain in a dryer and applying heat to the grain while in the dryer until the grain reaches a preselected moisture content that is above a market moisture content; thereafter
b) transferring the grain while still heated from the dryer to a bin;
c) conveying ambient air by use of a fan into the bottom of the grain in the bin and initially operating the fan at a comparatively low speed;
d) continuously monitoring the humidity and temperature of the air before and after passing the air through the grain in the bin;
e) when the humidity in the air exiting the grain is comparatively high, then raising the speed of the fan to effectively convey more air through the grain in the bin;
f) when the humidity of the air exiting the grain in the bin is comparatively low, but not the same humidity as the air going into the grain in the bin, then decrease the speed of the fan to decrease the amount of air conveyed into the grain in the bin;
g) selecting a temperature whereat the grain is considered cooled;
h) when the humidity of the air going into the grain and exiting the grain in the bin is almost equal, then first checking the temperature of the air exiting the grain in the bin, if the temperature of the air is at the cooled temperature both entering the grain and exiting, then the grain in the bin is considered cooled; whereas if the temperature of the air exiting the grain is higher than the cooled temperature, then the fan speed is reduced to convey less air into the grain in the bin.
